(19) United States
(12) Patent Application Publication
(10) Pub. No.: US 2016/0039141 A1
(43) Pub. Date: Feb. 11, 2016

(54) METHODS FOR DEBOSSING A REGION OF A THERMOPLASTIC MATERIAL'S SURFACE, AND RELATED ARTICLES AND SYSTEMS

(71) Applicant: MICROGREEN POLYMERS, INC., Arlington, WA (US)

(72) Inventors: Stephen W. Woolridge, Marysville, WA (US); Anthony La Salata, Arlington, WA (US)

(21) Appl. No.: 14/776,221

(22) PCT Filed: Mar. 17, 2014
(86) PCT No.: PCT/US14/30582

§ 371 Date: Sep. 14, 2015

Related U.S. Application Data
(60) Provisional application No. 61/793,896, filed on Mar. 15, 2013.

(51) Int. Cl. B29C 59/02; A47G 19/22; B32B 3/26; B29C 35/08; B32B 1/02

(52) U.S. Cl. CPC B29C 59/02; B29C 35/0805; B32B 1/02; B32B 3/26; A47G 19/2227; B29C 2035/0827; B29K 2105/041

(57) ABSTRACT

A method for debossing a surface of a thermoplastic material to which an ink is selectively applied. The force generated by the ink as it cures and adheres forms a decorative relief in the thermoplastic material's surface producing an article having aesthetic and tactile appeal without having to use a die to deform the surface and without having to apply and cure the ink in a step separate from the deformation of the surface.

### CROSS REFERENCE TO RELATED APPLICATION AND CLAIM OF PRIORITY

This application claims priority from commonly owned U.S. Provisional Patent Application 61/793,896 filed 15 Mar. 2013, and titled “UV-CURABLE INK IMPRINT ON AN EXPANDED THERMOPLASTIC ARTICLE AND METHOD FOR MAKING THE SAME”, presently pending and which is incorporated by reference.

### BACKGROUND

Embossing and debossing techniques are commonly used to create a decorative relief on a surface of a material to enhance the aesthetic and tactile appeal of the surface. Embossing creates a raised impression above the material's surface, and debossing creates a recessed impression below the material's surface. These two decorative effects are typically achieved by positioning the material between a die that includes a desired pattern and another die, and then pressing the dies toward each other to impart a permanent impression on the material. For embossing, the die that includes the desired pattern is pressed against the surface of the material that is opposite and under the surface of the material to be embossed. For debossing, the die that includes the desired pattern is pressed directly against the surface of the material to be debossed.

Often, ink is applied to a decorative relief on a surface to complement the aesthetic appeal of the relief. When used, ink may be applied to the surface of the material by coating the appropriate die with one or more pigments and pressing the inked die against the surface to transfer the ink to the surface while the die deforms the surface. Ink may also be applied to the surface in a separate step. For example, a flat pigmented image may be transferred onto the surface of the material by a printing plate, and then a die plate may be pressed against the surface where the image is located. Another example includes depositing a three-dimensional image onto a material's surface via a cover sheet that includes an ink that is released from the cover sheet via heat and pressure.

While embossing and/or debossing a material's surface enhances a product's appeal, such processes can incur additional costs because of extra processing steps and retooling the die for every new image or desired pattern. This is especially true if ink is used to complement the decorative relief formed in the surface.

### SUMMARY

In an aspect of the invention, a method for debossing a surface of a thermoplastic material includes: 1) applying an ink to a surface of a thermoplastic material such that the ink covers a region of the surface, 2) curing the ink; and 3) as the ink cures, applying a force against the region of the surface of the thermoplastic material that the ink was applied to such that the surface moves relative to the region of the surface that the ink was not applied to, causing the region of the surface that the ink was applied to to sink.

By debossing the surface of the thermoplastic material with the curing of the ink, one can form a decorative relief in the thermoplastic material's surface while securing ink to the surface. In this manner, one can quickly and easily enhance the aesthetic and tactile appeal of the surface and complement that appeal with ink without having to use a die to deform the surface and without having to apply and cure the ink in a step separate from the deformation of the surface.

In another aspect of the invention, an article of manufacture comprises a thermoplastic material having a surface that includes a debossed region, wherein the debossed region is formed by: 1) applying an ink to the surface of a thermoplastic material such that the ink covers a region of the surface, 2) curing the ink; and 3) as the ink cures, applying a force against the region of the surface of the thermoplastic material that the ink was applied to such that the surface moves relative to the region of the surface that the ink was not applied to, causing the region of the surface that the ink was applied to to sink.

### BRIEF DESCRIPTION OF THE FIGURES

FIG. 1 is a perspective view of a thermoplastic cup that includes a debossed region of its surface, according to an embodiment of the invention.

FIG. 2 is a photograph of a cross-section of a portion of a thermoplastic material having a microstructure that is included in the cup shown in FIG. 1, according to an embodiment of the invention.

FIG. 3 is a perspective, close-up view of the debossed region shown in FIG. 1, according to an embodiment of the invention.

FIG. 4 is a cross-sectional view of a surface with ink applied to a region of the surface, according to an embodiment of the invention.

FIG. 5 is a cross-sectional view of the surface in FIG. 4, showing a debossed region of the surface where the ink was applied, according to an embodiment of the invention.

FIG. 6 is a cross-sectional view of a surface with ink applied to a region of the surface, according to another embodiment of the invention.

FIG. 7 is a cross-sectional view of the surface in FIG. 6, showing a debossed region of the surface where the ink was applied, according to another embodiment of the invention.

### DETAILED DESCRIPTION

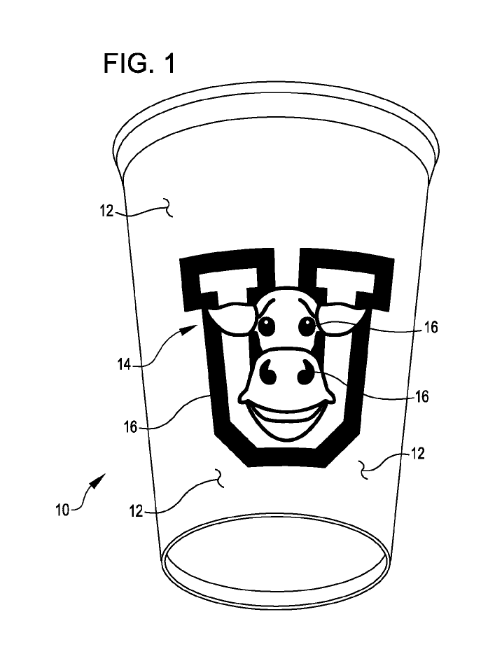

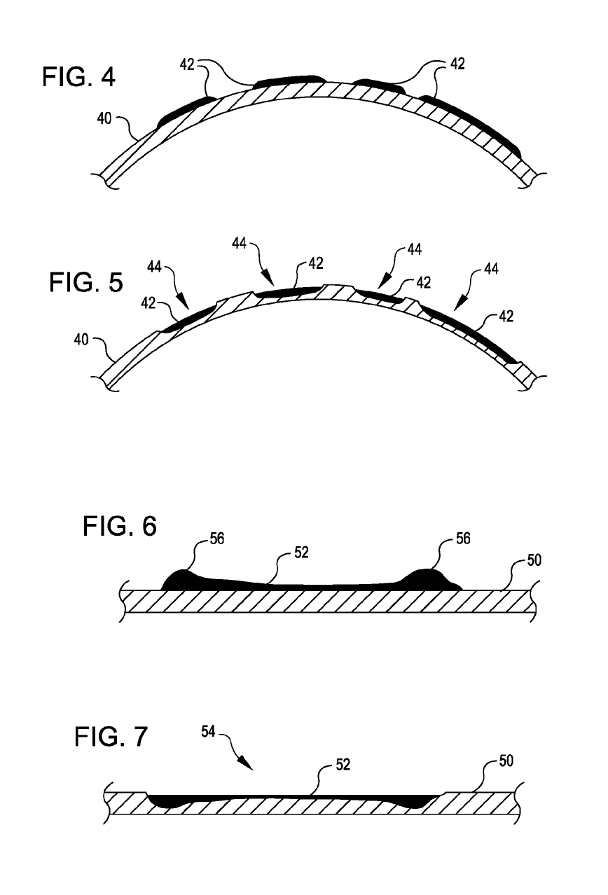

FIG. 1 is a perspective view of a thermoplastic cup 10, according to an embodiment of the invention. The cup 10 includes a surface 12 having a debossed region 14 (a portion of which is shown in greater detail in FIG. 3) to provide an aesthetic and tactile appeal to the cup 10. The cup 10 also includes ink 16 disposed in the debossed region 14 to complement the aesthetic appeal of the debossed region 14. Although a cup 10 is shown and discussed here, any article, such as a sign, a box, or any desired package or container may include a debossed region 14 and ink 16 as discussed herein. The debossed region 14 is formed in the surface 12 by first applying the ink 16 to the surface 12 (discussed in greater detail in conjunction with FIG. 4) and then curing the ink 16. Curing the ink 16 secures the ink 16 to the portion of the surface 12 that the ink 16 was applied to so that the ink 16, and thus the pattern that the ink 16 forms, remains intact and on the cup 10 while the cup 10 is packaged, shipped and eventually used by a person. Curing the ink 16 also causes the portion of the surface 12 that the ink 16 was applied to to sink below the portion of the surface 12 that the ink 16 was not applied to, and thus debosses the surface 12 to form the debossed region 14.

By debossing the surface 12 of the thermoplastic cup 10 with the curing of the ink 16, one can form a decorative relief in the thermoplastic cup's surface while securing the ink 16 to the surface 12. In this manner, one can quickly and easily enhance the aesthetic and tactile appeal of the surface 12 and complement that appeal with ink 16 without having to use a die to deform the surface 12 and without having to apply and cure the ink 16 in a step separate from the deformation of the surface 12.

The formation of the debossed region 14 by curing the ink 16 is an unexpected result that appears to be a function of the amount of energy absorbed by the ink 16. The amount of energy that the ink 16 absorbs depends on the intensity of the energy exposed to the ink 16 and the duration of the exposure—dwell period. As the intensity of the energy exposed to the ink increases, the amount of energy absorbed by the ink 16 also increases for a given dwell period. And, as the dwell period lengthens, the amount of energy absorbed by the ink 16 also increases for a given energy intensity. As the ink 16 cures, the ink 16 hardens and contracts into a form that is denser than the ink 16 before curing. The hardening and contraction of the ink 16, it is believed, generates a force that is exerted on the surface 12 that the ink 16 was applied to, causing the surface 12 to compress. More specifically, it is believed that the weight of the denser ink 16 lying on top of the surface 12 exerts a force against the surface 12, and that the contraction of the ink 16 that is coupled to the surface 12 pulls on the surface in a direction transverse to the surface. The energy absorbed by the ink 16 may also heat the surface 12 to a temperature at which the surface 12 may deform in response to the force exerted on the surface 12. If the surface 12 is amorphous or slightly crystallized, then the heat experienced by the surface may cause the surface to further crystallize, and thus contract. In one or more of these manners, it is believed, the debossed region 14 may be formed in the surface 12.

Other factors may also influence the formation of the debossed region 14. For example, the color and density of the ink 16 that is applied to the surface 12 may influence the formation of the debossed region 14 because the final weight of the ink 16 after the ink 16 cures depends on the density of the ink 16 before the ink 16 cures. In addition, the color and density of the ink 16 affects the amount of energy absorbed by the ink 16 to cure it, and thus the amount of heat that the surface 12 experiences as the ink 16 cures. Another factor that may influence the formation of the debossed region 14 is the thermoplastic material and the material's microstructure. For example, the surface 12 of a thermoplastic material that has a microcellular core may be more easily deformed than the same material that does not have a microcellular core. Another factor that may also influence the formation of the debossed region 14 is the amount of pressure that a printing pad applies to the surface 12 to deposit the ink 16 onto the surface 12. For example, pressure applied to the surface 12 may cause the ink 16 to concentrate at, or squeeze-out to, the edge of the desired pattern on the surface 12. As discussed in conjunction with FIGS. 6 and 7, this may cause the edge of the debossed region 14 to sink further below the portion of the surface 12 that is not debossed than the other portions of the debossed region 14.

Still referring to FIG. 1, the cup's material that includes the surface 12 that is debossed may be any desired thermoplastic material. For example, in this and other embodiments the material includes polyethylene terephthalate (PET). Additionally or alternatively the thermoplastic material may include one or more of the following: polystyrene, polycarbonate, acrylonitrile-butadiene-styrene, glycol modified PET, polyethylene, polypropylene, NORYL (a blend of polyphenylene oxide and polystyrene), polyvinyl chloride, and crystallizable polyethylene terephthalate (CPET).

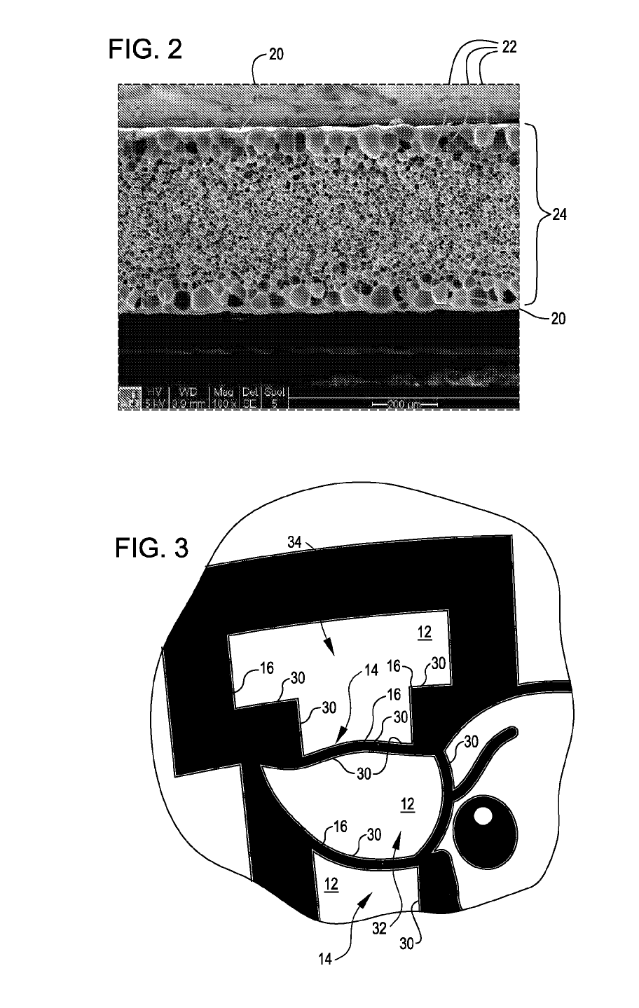

In addition, the microstructure of the cup's material that includes the surface 12 that is debossed may include any desired microstructure. For example, as shown in FIG. 2, in this and other embodiments the microstructure includes a skin 20 (here two), and many (typically 10⁸ or more per cubic centimeter) microcellular bubbles 22 (only three labeled for clarity) whose cell sizes typically range from 0.1 to 200 micrometers and are closed. These many bubbles or closed-cells 22 form a microcellular core 24 that is sandwiched between the skins 20. Each skin 20 is a smooth, outer-layer whose microstructure does not include closed-cells 22 or at most far fewer closed-cells 22 than the microcellular core 24, and is thus substantially solid. In this and other embodiments, each skin 20 is integral to the closed-cells 22. More specifically, each skin 20 and the plurality of closed-cells 22 are formed during a single process and from the same initial sheet of solid thermoplastic material. An example of such a process is described in PCT patent application PCT/US2011/048270, filed 18 Aug. 2011, titled “CONTAINERS AND OVERWRAPS COMPRISING THERMOPLASTIC POLYMER MATERIAL, AND RELATED METHODS FOR MAKING THE SAME”, hereby incorporated by reference. In other embodiments, the skin 20 may not be integral to the closed-cells 22, but formed after the closed-cells 22 have been formed. In still other embodiments, an extrusion process may be used to produce expanded plastics. In such a process, solid thermoplastic granules are fed into an extruder along with a chemical additive or physical blowing agent and mixed together under high pressure and temperature to form a molten solution. The polymer gas solution is subsequently ejected out of a die to expand into a cellular structure that has many closed-cells and/or open-cells.

The size of each closed cell 22 may be any desired size, and the distribution of the closed cells 22 throughout the thickness of the material may be any desired distribution. For example, in this and other embodiments the size of each closed cell ranges between 1 and 60 micrometers long at its maximum dimension that extends across the void within the cell, and the closed cells may be uniformly dispersed throughout the microcellular core 24. Because the geometry of each closed-cell is rarely, if at all, a perfect sphere, the size of each closed cell is arbitrarily identified as the length of the longest chord that extends through the void within the closed cell. For example, the size of an oblong cell would be the length of the longest chord that extends in the same direction as the cell's elongation, and the size of a sphere would be the length of the sphere's diameter.

With the many cells 22 in the microcellular core 24, the surface 12 of the cup 10 may be more easily deformed into a debossed region 14 when heated and subjected to a force as the ink 16 cures. And, with a smooth skin 20, one can apply ink 16 to form a a precise pattern on the surface 12, which can allow one to subsequently form a precise, high-quality relief in the debossed region 14, and to complement the relief with a precise, high-quality graphic.

Still referring to FIG. 1, the ink 16 may be any desired ink 16, and thus curing the ink 16 may be accomplished in any desired manner capable of curing the desired ink 16. For example, in this and other embodiments the ink 16 includes a UV curable ink, an ink that cures when exposed to ultraviolet (UV) radiation. The ink 16 may be a free-radical, UV-curable ink or it may be a cationic, UV-curable ink. More specifically, the ink 16 includes a Series 77 Dry Offset Ink manufactured by the Zeller+Gmelin Corporation. In other embodiments, the ink 16 may include other dry-offset inks, and/or other inks that may be cured by other means.

Other embodiments are possible. For example, an ink 16 may be used that does not require curing to secure the ink 16 to the surface 12. In such examples, one may apply the ink 16 to the surface 12 to form a desired pattern, and then warm the ink 16 with energy that is directed to the ink 16 and not to the surface 12 adjacent the ink 16 to minimize warming the surface 12 adjacent the ink 16. This may be accomplished by shielding the surface 12 adjacent the ink 16, or by using a form of energy that can be accurately directed to a precise location. This may also be accomplished by adding a component to the ink 16 that absorbs much of the energy directed to the ink 16 and converts the absorbed energy into heat.

FIG. 3 is a perspective, close-up view of a portion of the debossed region 14 shown in FIG. 1, according to an embodiment of the invention. As shown in FIG. 3, the debossed region 14 includes a bottom portion (not shown) on top of which the cured ink 16 resides, and a sloped portion 30 that is a transition from the bottom portion to the surface 12 that is not debossed. In this embodiment, the ink 16 that helps define the cow's ear 32 is black, and the ink 16 that helps define the “U” 34 is green. In addition, the sloped portion 30 that surrounds the cow's ear 32 is wider than the sloped portion that surrounds the “U” 34. This difference results from the different color of the inks 16, and thus the difference in the amount of heat absorbed by each while they cure. This difference may also result from the difference in density between the two inks 16.

FIGS. 4 and 5 are cross-sectional views of a surface 40, according to an embodiment of the invention. FIG. 4 shows the surface 40 after ink 42 has been applied but before the ink 42 is cured to generate a debossed region. FIG. 5 shows the surface 40 after the ink 42 has been cured to generate a debossed region 44.

The ink 42 may be applied to the surface 40 in any desired manner to form any desired visual pattern. For example, in this and other embodiments, the ink 42 is applied to the surface 42 via a dry offset process in which the ink 42 is initially applied to a rubber pad or “blanket” in any desired visual pattern. The rubber pad or “blanket” is then pressed against the surface 40 to transfer the ink 42 to the surface 40 in the same desired visual pattern. After the ink 42 is applied to the surface 40, the ink 42 is cured, as previously discussed, to generate the debossed region 44.

FIGS. 6 and 7 are cross-sectional views of a surface 50, according to an embodiment of the invention. FIG. 6 shows the surface 50 after ink 52 has been applied but before the ink 52 is cured to generate a debossed region. FIG. 7 shows the surface 50 after the ink 52 has been cured to generate a debossed region 54.

In this and other embodiments, the ink 52 is applied to the surface 50 in such a way that regions of the surface 50 receive more or a higher concentration of ink 52 than other regions of the surface 50. For example, the ink 52 includes two portions 56 that include more ink 52 than their adjacent portions. In a dry offset process, this may be accomplished by exerting more force that is necessary to adequately transfer the ink 52 from the rubber pad or “blanket” to the surface 52. The excess force causes the ink 52 to concentrate at, or squeeze-out to, the edge of the visual pattern on the surface 50. Then, when the portions 56 of the ink 52 cure they cause the surface 50 underneath them to sink further below the portion of the surface 52 that is not debossed than the other portions of the debossed region 54 that lie underneath the ink 52 between the portions 56.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method for debossing a surface of a thermoplastic material, the method comprising:
applying an ink to a surface of a thermoplastic material such that the ink covers a region of the surface;
curing the ink; and
as the ink cures, applying a force against the region of the surface of the thermoplastic material that the ink was applied to such that the surface moves relative to the region of the surface that the ink was not applied to, causing the region of the surface that the ink was applied to to sink.

2. The method of claim 1 wherein the force applied against the region of the surface that the ink was applied to is generated by the ink hardening and contracting as the ink cures.

3. The method of claim 1 wherein curing the ink includes exposing the ink to ultraviolet radiation.

4. The method of claim 1 wherein the ink that covers the region of the surface forms a visual design on the region of the surface that the ink was applied to.

5. The method of claim 1 wherein the ink that covers the region of the surface forms a visual design in the region of the surface that the ink was not applied to.

6. The method of claim 1 wherein the ink includes a free-radical, UV-curable ink.

7. The method of claim 1 wherein the ink includes a cationic, UV-curable ink.

8. The method of claim 1 wherein the surface of the thermoplastic material is solid.

9. The method of claim 1 wherein the thermoplastic material includes a solid skin and a microcellular core.

10. The method of claim 1 wherein the surface of the thermoplastic material includes a curve in at least two dimensions.

11. An article of manufacture, the article comprising:
a thermoplastic material having a surface that includes a debossed region, wherein the debossed region is formed by:
applying an ink to the surface of a thermoplastic material such that the ink covers a region of the surface;
curing the ink; and
as the ink cures, applying a force against the region of the surface of the thermoplastic material that the ink was applied to such that the surface moves relative to the region of the surface that the ink was not applied to, causing the region of the surface that the ink was applied to to sink.

11. The article of claim 11 wherein the article is a cup.

12. The article of claim 11 wherein the article is a cup and the thermoplastic material includes a solid skin and a microcellular core.

13. The article of claim 11 wherein curing the ink includes exposing the ink to ultraviolet radiation.
